(19) United States
(12) Patent Application Publication
(10) Pub. No.: US 2016/0353286 A1
(43) Pub. Date: Dec. 1, 2016

(54) WIRELESS COMMUNICATION DEVICE AND COMMUNICATION SYSTEM

(71) Applicant: FUJITSU LIMITED, Kawasaki-shi (JP)

(72) Inventors: Yoshiharu Tajima, Yokohama (JP); Tsuyoshi Shimomura, Yokohama (JP); Hiroyuki Seki, Kawasaki (JP)

(73) Assignee: FUJITSU LIMITED, Kawasaki-shi (JP)

(21) Appl. No.: 15/232,399

(22) Filed: Aug. 9, 2016

Related U.S. Application Data
(63) Continuation of application No. PCT/JP2014/069495, filed on Jul. 23, 2014.

(30) Foreign Application Priority Data
Mar. 12, 2014 (JP) 2014-049399

(51) Int. Cl. H04W 16/14; H04B 17/318; H04W 72/08

(52) U.S. Cl. CPC H04W 16/14; H04W 72/082; H04B 17/318

(57) ABSTRACT

A wireless communication device is in a communication system that includes a first wireless system employing a first communication method in which communication is started when a sensed power value is smaller than a first set value of a threshold, and includes a second wireless system employing a second communication method in which communication is performed by scheduling performed by a base station. The wireless communication device employs the first communication method. The wireless communication device includes: a processor that executes a process including: determining presence or absence of interference from the second wireless system based on information received from a different wireless communication device employing the first communication method; and changing the threshold to a second set value when it is determined that there is the interference.

### CROSS-REFERENCE TO RELATED APPLICATION

This application is a continuation application of International Application No. PCT/JP2014/069495 filed on Jul. 23, 2014 which claims the benefit of priority of the prior Japanese Patent Application No. 2014-049399, filed on Mar. 12, 2014, the entire contents of which are incorporated herein by reference.

### FIELD

The embodiments discussed herein are related to a wireless communication device and a communication system.

### BACKGROUND

In recent years, wireless traffic continues to increase rapidly, and a demand for frequencies that are a limited resource is growing. Therefore, “cognitive radio” has been studied as one of the technologies for achieving effective use of the frequencies.

As an optimal frequency selected by the cognitive radio, a “white space” is particularly attracting attention. The “white space” is a frequency band that is not used by a provider (operator) who offers specific wireless service, such as a television broadcasting service, among frequency bands that the provider is licensed to use. Such unused frequency band is provided to, for example, prevent interference between frequency channels. Examples of the white space include an empty channel in the frequency bands for television broadcasting. The white space as the empty channel in the frequency bands for television broadcasting may be referred to as a “television white space (TVWS)”.

In the cognitive radio using the white space, a wireless system that preferentially uses a licensed frequency band may be called a “primary system”, and a wireless system that performs communication by using a white space may be called a “secondary system”. Examples of the primary system include a television broadcasting system.

Furthermore, the secondary system may include various wireless systems. That is, areas of a plurality of wireless systems that use the same frequency may be arranged in an overlapping manner. The secondary system may include, for example, a “first wireless system” that employs a “first communication method” in which communication is started when a sensed power value (that is, a carrier sense value) is smaller than a threshold. Examples of the “first communication method” include a wireless Local Area Network (LAN) that uses Carrier Sense Multiple Access/Collision Avoidance (CSMA/CA) as an access control method. For another example, a wireless LAN defined by IEEE802.11af that is a communication standard may be used. The secondary system may include, for example, a “second wireless system” that employs a “second communication method” in which communication is performed by scheduling performed by a base station. Examples of the “second communication method” include a communication system defined by IEEE802.22 that is a communication standard and a communication system defined by 3rd Generation Partnership Project Long Term Evolution (3GPP LTE).
Patent Document 1: Japanese Laid-open Patent Publication No. 2012-080312
Patent Document 2: Japanese Laid-open Patent Publication No. 2013-183226
Patent Document 3: Japanese Laid-open Patent Publication No. 2013-005339
Non Patent Document 1: “Mechanisms for LTE Coexistence in TV White Space”, Mihaela Beluri, and eight others, 2012 IEEE International Symposium on Dynamic Spectrum Access Networks, pp. 317-326

Incidentally, in the above-described “first communication method”, when the carrier sense is performed and a sensed power value is equal to or greater than a threshold, that is, in the case of a busy state, transmission is suspended and the transmission is started after the sensed power value is reduced to below the threshold. Therefore, if the “second wireless system” and the “first wireless system” that use the same frequency are mixed in a single area, communication by the second wireless system is continuously performed, and therefore, a wireless communication device using the “first communication method” is not able to perform communication. That is, a throughput of the “first wireless system” is reduced.

Therefore, it may be possible to apply a periodic no-transmission interval (that is, a gap), that is, intermittent transmission, to the “second wireless system”.

However, if the intermittent transmission is applied to the “second wireless system”, a throughput of the “second wireless system” is reduced while reduction of the throughput of the “first wireless system” can be reduced. For example, if a ratio of a transmission interval and a no-transmission interval of the intermittent transmission is 1:1, the throughput is reduced to half as compared to a case in which the intermittent transmission is not applied. This may occur not only when a cover area of the “second wireless system” and a cover area of the “first wireless system” completely overlap each other, but also when the cover areas partly overlap each other. This is because the intermittent transmission is applied to the entire “second wireless system” even when the cover areas partly overlap each other.

### SUMMARY

According to an aspect of the embodiments, a wireless communication device is in a communication system that includes a first wireless system employing a first communication method in which communication is started when a sensed power value is smaller than a first set value of a threshold, and includes a second wireless system employing a second communication method in which communication is performed by scheduling performed by a base station. The wireless communication device employs the first communication method. The wireless communication device includes: a processor that executes a process including: determining presence or absence of interference from the second wireless system based on information received from a different wireless communication device employing the first communication method; and changing the threshold to a second set value when it is determined that there is the interference.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a communication system of a first embodiment;

FIG. 2 is a block diagram illustrating an example of a wireless communication device of the first embodiment;

FIG. 3 is a block diagram illustrating an example of a threshold control unit of the first embodiment;

FIG. 4 is a flowchart illustrating an example of a processing operation performed by the wireless communication device of the first embodiment;

FIG. 5 is a flowchart illustrating an example of a processing operation performed by the wireless communication device of the first embodiment;

FIG. 6 is a block diagram illustrating an example of a wireless communication device of a second embodiment;

FIG. 7 is a block diagram illustrating an example of a threshold control unit of the second embodiment;

FIG. 8 is a diagram illustrating a hardware configuration example of the wireless communication device;

FIG. 9 is a diagram illustrating an overall configuration example of a mobile communication system according to a third embodiment;

FIG. 10 is a block diagram illustrating a configuration example of a base station of a first wireless system;

FIG. 11 is a block diagram illustrating a configuration example of a base station of a second wireless system;

FIG. 12 is a block diagram illustrating a configuration example of a mobile station of the first wireless system;

FIG. 13 is a flowchart illustrating an example of a process performed by the mobile station of the first wireless system;

FIG. 14 is a diagram illustrating an example of a format of a signal of an intermittent transmission request;

FIG. 15A is a flowchart illustrating an example of a process on an intermittent transmission request by the base station of the first wireless system;

FIG. 15B is a flowchart illustrating an example of a process on an intermittent transmission stop request by the base station of the first wireless system;

FIG. 16 is a flowchart illustrating an example of a process performed by the base station of the second wireless system;

FIG. 17 is a timing diagram for explaining control of intermittent transmission according to the third embodiment;

FIG. 18 is a diagram illustrating an overall configuration example of a mobile communication system according to a fourth embodiment;

FIG. 19 is a timing diagram for explaining control of intermittent transmission according to the fourth embodiment;

FIG. 20 is a block diagram illustrating a configuration example of a base station of a first wireless system;

FIG. 21 is a block diagram illustrating a configuration example of a base station of a second wireless system;

FIG. 22 is a block diagram illustrating a configuration example of a mobile station of the first wireless system;

FIG. 23 is a flowchart illustrating an example of a process performed by the mobile station of the first wireless system; and

FIG. 24 is a flowchart illustrating an example of a process performed by the base station of the second wireless system.

### DESCRIPTION OF EMBODIMENT(S)

Preferred embodiments will be explained with reference to accompanying drawings. The wireless communication device and the communication system of the disclosed technology are not limited by the embodiments. Furthermore, the components having the same functions in the embodiments are denoted by the same symbols, and the same explanation will not be repeated.

### [a] First Embodiment

### Overview of a Communication System

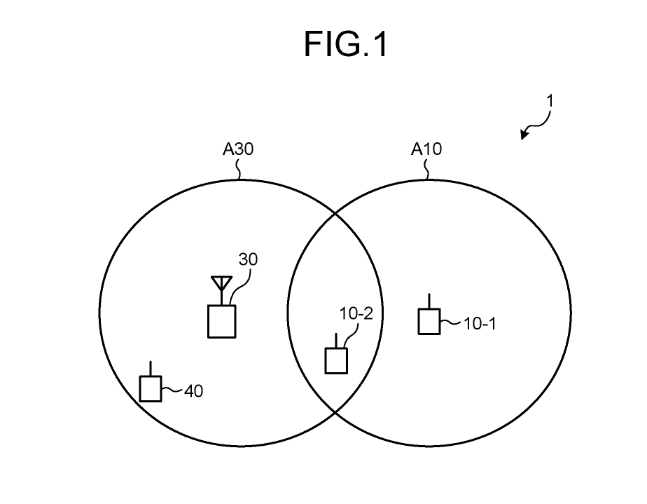

FIG. 1 is a diagram illustrating an example of a communication system of a first embodiment. In FIG. 1, a communication system 1 includes wireless communication devices 10-1 and 10-2 that employ a “first communication method”, and includes a base station 30 and a terminal 40 that employ a “second communication method”. The base station 30 and the terminal 40 are a part of a “second wireless system”. Furthermore, the wireless communication devices 10-1 and 10-2 are a part of a “first wireless system”. The “first wireless system” and the “second wireless system” use the same frequency (in this example, a TVWS).

In the “second communication method”, communication between the base station 30 and the terminal 40 is performed by scheduling performed by the base station 30 as described above. Furthermore, in the “first communication method”, each of the wireless communication devices 10-1 and 10-2 starts communication when a sensed power value (that is, a carrier sense value) is smaller than a “first set value” of a busy threshold. That is, each of the wireless communication devices 10-1 and 10-2 performs communication by using, for example, the CSMA/CA as an access control method. The “first set value” is a reference value of the threshold. Furthermore, in FIG. 1, an area A10 indicates a cover area of the wireless communication device 10-1, and an area A30 indicates a cover area of the base station 30. Incidentally, in the following, the wireless communication devices 10-1 and 10-2 may be collectively referred to as a wireless communication device 10 when they are not specifically distinguished from each other. Furthermore, in the following, for simplicity of explanation, the two wireless communication devices 10, the single base station 30, and the single terminal 40 are provided; however, the numbers of the devices are not specifically limited. Moreover, in the following description, it is assumed that the “second communication method” is a communication method defined by IEEE802.22, and the “first communication method” is a wireless LAN communication method.

The wireless communication device 10-2 determines presence or absence of interference from the second wireless system, based on “predetermined information” received from the wireless communication device 10-1 that is a different wireless communication device employing the first communication method. For example, the wireless communication device 10-2 determines that there is interference from the second wireless system when a signal subjected to a reception process includes “predetermined information” indicating that the second wireless system is located around the wireless communication device 10-1 and when a length of a period, in which the carrier sense value is equal to or greater than the “first set value”, is equal to or greater than a predetermined value.

When determining that there is interference, the wireless communication device 10-2 changes the value of the busy threshold to a “second set value”. For example, the “second set value” is greater than the “first set value”. That is, when determining that there is interference, the wireless communication device 10-2 changes the busy threshold so as to reduce the chance of being determined as busy.

As described above, the wireless communication device 10-2 increases the busy threshold when it is estimated that there is interference from a first communication system; therefore, the wireless communication device 10-2 can easily start communication. Consequently, it becomes possible to prevent reduction of the throughput of the “first wireless system” without applying intermittent transmission to the “second wireless system”. Furthermore, it becomes possible to prevent reduction of the throughput of the “second wireless system” because intermittent transmission is not applied to the “second wireless system”. As a result, it becomes possible to reduce reduction of the throughput of the entire communication system 1.

Configuration Example of the Wireless Communication Device

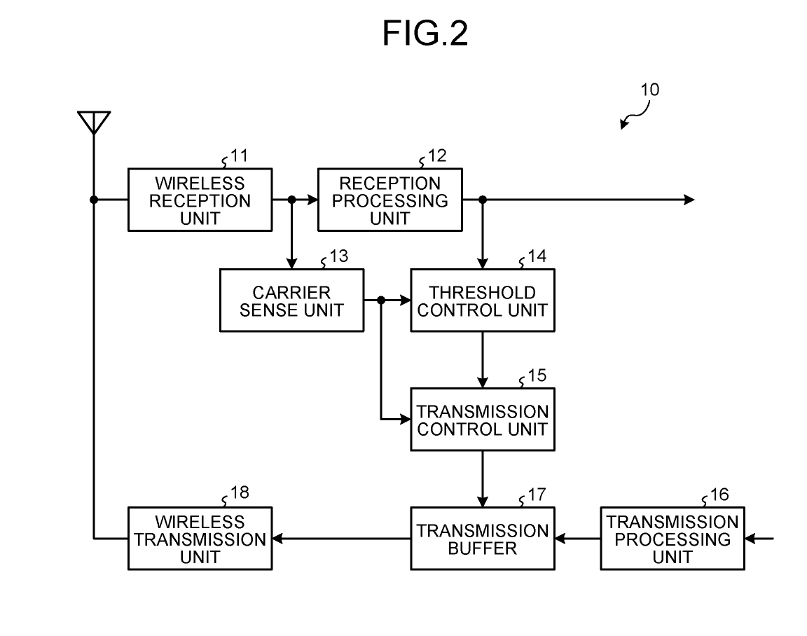

FIG. 2 is a block diagram illustrating an example of the wireless communication device of the first embodiment. In FIG. 2, the wireless communication device 10-2 includes a wireless reception unit 11, a reception processing unit 12, a carrier sense unit 13, a threshold control unit 14, a transmission control unit 15, a transmission processing unit 16, a transmission buffer 17, and a wireless transmission unit 18. The wireless communication device 10-1 has the same configuration as the wireless communication device 10-2.

The wireless reception unit 11 performs a predetermined wireless reception process (down-conversion, analog-to-digital conversion, or the like) on a signal received via an antenna, and outputs the received signal subjected to the predetermined wireless reception process to the reception processing unit 12 and the carrier sense unit 13.

The reception processing unit 12 performs a predetermined reception process (demodulation, decoding, or the like) on the received signal obtained from the wireless reception unit 11, and outputs the received signal subjected to the predetermined reception process.

The carrier sense unit 13 measures, as a carrier sense value, electric power of the signal received from the wireless reception unit 11, and outputs the measured carrier sense value to the threshold control unit 14 and the transmission control unit 15.

The threshold control unit 14 determines presence or absence of interference from the second wireless system, based on “predetermined information” received from the wireless communication device 10-1 that is a different wireless communication device employing the first communication method. For example, the threshold control unit 14 determines that there is interference from the second wireless system when the signal received from the reception processing unit 12 includes “predetermined information” indicating that the second wireless system is located around the wireless communication device 10-1 and when a length of a period, in which the carrier sense value received from the carrier sense unit 13 is equal to or greater than the “first set value”, is equal to or greater than a predetermined value.

When determining that there is interference, the threshold control unit 14 changes the value of the busy threshold to the “second set value”. For example, when determining that there is interference, the threshold control unit 1 outputs a “set value change instruction” including the second set value to the transmission control unit 15.

Incidentally, the threshold control unit 14 measures a reception level (that is, a “desired wave level”) of the signal received from the wireless communication device 10-1. Then, the threshold control unit 14 calculates the above-described second set value based on “needed communication quality” of the wireless communication device 10-2 and the measured “desired wave level”.

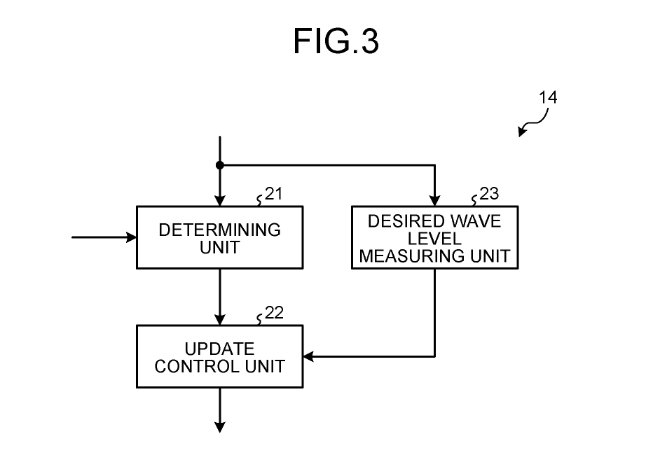

FIG. 3 is a block diagram illustrating an example of the threshold control unit of the first embodiment. In FIG. 3, the threshold control unit 14 includes a determining unit 21, an update control unit 22, and a desired wave level measuring unit 23. A process of determining presence or absence of interference from the second wireless system is performed by the determining unit 21, and a process of controlling a change in the busy threshold is performed by the update control unit 22. Furthermore, a process of measuring the desired wave level is performed by the desired wave level measuring unit 23.

For example, the update control unit 22 stores the “needed communication quality” of the wireless communication device 10-2. The update control unit 22 calculates the “second set value” based on the “needed communication quality” and the “desired wave level” received from the desired wave level measuring unit 23. For example, the “second set value” is calculated as a ratio of the “desired wave level” to the “needed communication quality”. Therefore, the wireless communication device 10-2 can perform communication that satisfies the needed communication quality even when the wireless communication device 10-2 is interfered with by the second wireless system. Incidentally, the “needed communication quality” may be represented by a ratio of the “desired wave level” to an “interference wave level”.

The transmission control unit 15 controls transmission in accordance with the first communication method. For example, the transmission control unit 15 uses the CSMA/CA as the access control method. For example, if the carrier sense value is smaller than a set value of the busy threshold, the transmission control unit 15 outputs a “transmission instruction signal” to the transmission buffer. In contrast, if the carrier sense value is equal to or greater than the set value of the busy threshold, the transmission control unit 15 does not output the “transmission instruction signal” to the transmission buffer. That is, the transmission control unit 15 suspends transmission when the carrier sense value received from the carrier sense unit 13 is equal to or greater than the set value of the busy threshold, and starts transmission when the carrier sense value is reduced to below the busy threshold.

Furthermore, upon receiving the “set value change instruction” from the threshold control unit 14, the transmission control unit 15 changes the busy threshold to the second set value. Incidentally, the reference value of the busy threshold is the first set value. If the transmission control unit 15 does not receive the “set value change instruction” from the threshold control unit 14 within a predetermined period after changing the busy threshold to the second set value, the transmission control unit 15 may change the busy threshold back to the first set value.

The transmission processing unit 16 performs a predetermined transmission process (for example, encoding, modulation, or the like) on input transmission data, and outputs the obtained transmission signal to the transmission buffer 17.

The transmission buffer 17 temporarily stores therein the transmission signal received from the transmission processing unit 16, and upon receiving the “transmission instruction signal” from the transmission control unit 15, outputs a transmission signal corresponding to the “transmission instruction signal” to the wireless transmission unit 18.

The wireless transmission unit 18 performs a predetermined wireless transmission process (digital-to-analog conversion or the like) on the transmission signal received from the transmission buffer 17, and transmits the transmission signal subjected to the predetermined wireless transmission process via an antenna.

Example of an Operation Performed by the Wireless Communication Device

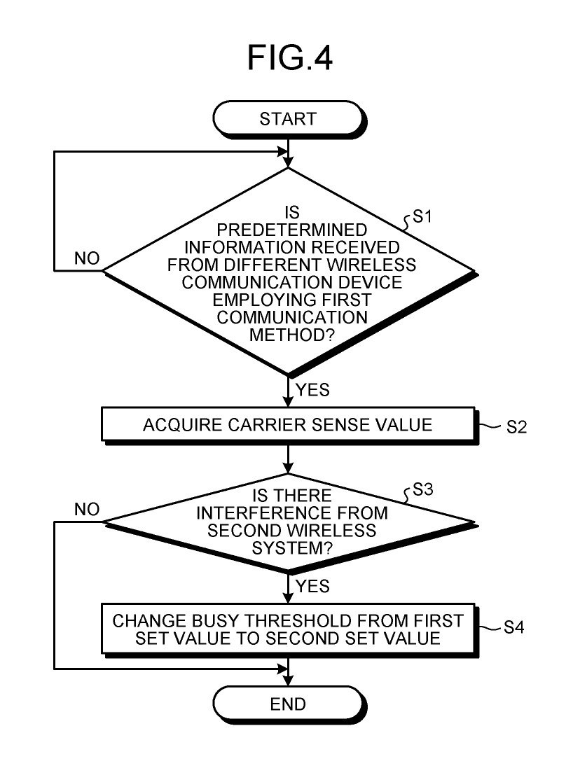

An example of a processing operation performed by the wireless communication device 10 with the above configuration will be described below. FIG. 4 is a flowchart illustrating an example of the processing operation performed by the wireless communication device of the first embodiment. In FIG. 4, a processing operation performed by the threshold control unit 14 is particularly illustrated. The processing flow illustrated in FIG. 4 may be repeated at a predetermined period.

The threshold control unit 14 determines whether “predetermined information” is received from the wireless communication device 10-1 that is a different wireless communication device employing the first communication method (Step S1). That is, the threshold control unit 14 determines whether the “predetermined information” is included in the signal received from the reception processing unit 12. In this example, the “predetermined information” is, for example, a 1-bit signal indicating whether the base station 30 of the second wireless system is located around the wireless communication device 10-1. The threshold control unit 14 waits until receiving the “predetermined information” (NO at Step S1), and upon receiving the “predetermined information” (YES at Step S1), acquires a carrier sense value from the carrier sense unit 13 (Step S2).

The threshold control unit 14 determines whether there is interference from the second wireless system (Step S3). In the first embodiment, the threshold control unit 14 determines that there is interference when, for example, the signal received from the reception processing unit 12 includes the “predetermined information” indicating that the second wireless system is located around the wireless communication device 10-1 and when a length of a period, in which the carrier sense value received from the carrier sense unit 13 is equal to or greater than the “first set value”, is equal to or greater than the predetermined value.

When determining that there is interference (YES at Step S3), the threshold control unit 14 changes the busy threshold to the second set value (Step S4). In contrast, when it is determined that there is no interference (NO at Step S3), the flow of the process ends.

Case in which Time Division Duplex (TDD) is Applied to the Second Wireless System

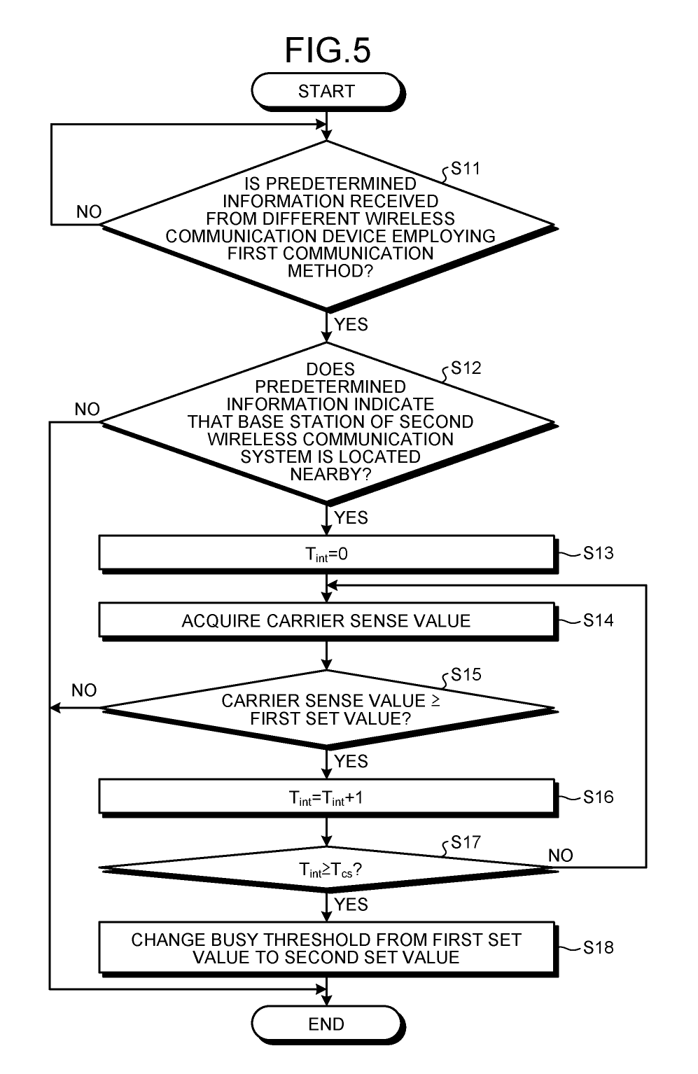

A case in which time division duplex (TDD) is applied to the second wireless system will be described below. FIG. 5 is a flowchart illustrating an example of a processing operation performed by the wireless communication device of the first embodiment. FIG. 5 illustrates a processing operation performed by the threshold control unit 14 when time division duplex (TDD) is applied to the second wireless system. Incidentally, the processing flow illustrated in FIG. 5 may be repeated at a predetermined period.

The threshold control unit 14 determines whether the “predetermined information” is received from the wireless communication device 10-1 that is a different wireless communication device employing the first communication (Step S11). That is, similarly to Step 1 as described above, the threshold control unit 14 determines whether the “predetermined information” is included in the signal received from the reception processing unit 12. The threshold control unit 14 waits until receiving the “predetermined information” (NO at Step S11), and upon receiving the “predetermined information” (YES at Step S11), determines whether the “predetermined information” indicates that the base station 30 of the second wireless system is located around the wireless communication device 10-1 (Step S12).

When determining that the “predetermined information” indicates that the base station 30 of the second wireless system is located around the wireless communication device 10-1 (YES at Step S12), the threshold control unit 14 sets a value Tᵢₙₜ to zero (Step S13). As will be described later, Tᵢₙₜ is the number of continuous downlink periods, in which the carrier sense value is equal to or greater than the first set value, in the second wireless system.

The threshold control unit 14 acquires the carrier sense value from the carrier sense unit 13 (Step S14).

The threshold control unit 14 determines whether the acquired carrier sense value is equal to or greater than the first set value of the busy threshold (Step S15).

When determining that the acquired carrier sense value is equal to or greater than the first set value of the busy threshold (YES at Step S15), the threshold control unit 14 increments the value Tᵢₙₜ (Step S16).

The threshold control unit 14 determines whether the value Tᵢₙₜ is equal to or greater than a predetermined value T_{CS} (Step S17).

When determining that the value Tᵢₙₜ is equal to or greater than the predetermined value T_{CS} (YES at Step S17), the threshold control unit 14 changes the busy threshold to the second set value (Step S18).

When it is determined that the value Tᵢₙₜ is smaller than the predetermined value T_{CS} (NO at Step S17), the processing step returns to Step S14. Furthermore, when it it determined that the “predetermined information” does not indicate that the base station 30 of the second wireless system is located around the wireless communication device 10-1 (NO at Step S12), the flow of the process ends. Moreover, when it is determined that the acquired carrier sense value is smaller than the first set value of the busy threshold (NO at Step S15), the flow of the process ends.

As described above, according to the first embodiment, the determining unit 21 of the wireless communication device 10-2 determines presence or absence of interference from the second wireless system based on the “predetermined information” received from the wireless communication device 10-1 that is a different wireless communication device employing the first communication method. Then, when it is determined that there is interference, the update control unit 22 changes the busy threshold to the second set value.

With the configuration of the wireless communication device 10-2, the busy threshold can be increased when it is estimated that there is interference from the first communication system, and therefore, the wireless communication device 10-2 can easily start communication. Consequently, it becomes possible to prevent reduction of the throughput of the “first wireless system” without applying intermittent transmission to the “second wireless system”. Furthermore, it becomes possible to prevent reduction of the throughput of the “second wireless system” because intermittent transmission is not applied to the “second wireless system”. As a result, it becomes possible to reduce reduction of the throughput of the entire communication system 1.

For example, the determining unit 21 determines that there is interference from the second wireless system when the signal received from the reception processing unit 12 includes the “predetermined information” indicating that the second wireless system is located around the wireless communication device 10-1 and when a length of a period, in which the carrier sense value received from the carrier sense unit 13 is equal to or greater than the “first set value”, is equal to or greater than the predetermined value.

Furthermore, the update control unit 22 calculates the second set value based on a ratio between the “needed communication quality” of the wireless communication device 10-2 and the reception level (that is, the “desired wave level”) of the signal received from the wireless communication device 10-1.

With the configuration of the wireless communication device 10-2, it is possible to perform communication that satisfies the needed communication quality even when there is interference from the second wireless system.

### [b] Second Embodiment

In a second embodiment, a wireless communication device determines presence or absence of interference from a second wireless system based on “predetermined information” indicating a location of the second wireless system located around another wireless communication device and based on a location of the own wireless communication device. Incidentally, a basic configuration of a communication system of the second embodiment is the same as the communication system 1 of the first embodiment; therefore, explanation will be given with reference to FIG. 1. In the second embodiment, wireless communication devices 50-1 and 50-2 are used instead of the wireless communication devices 10-1 and 10-2 of the first embodiment.

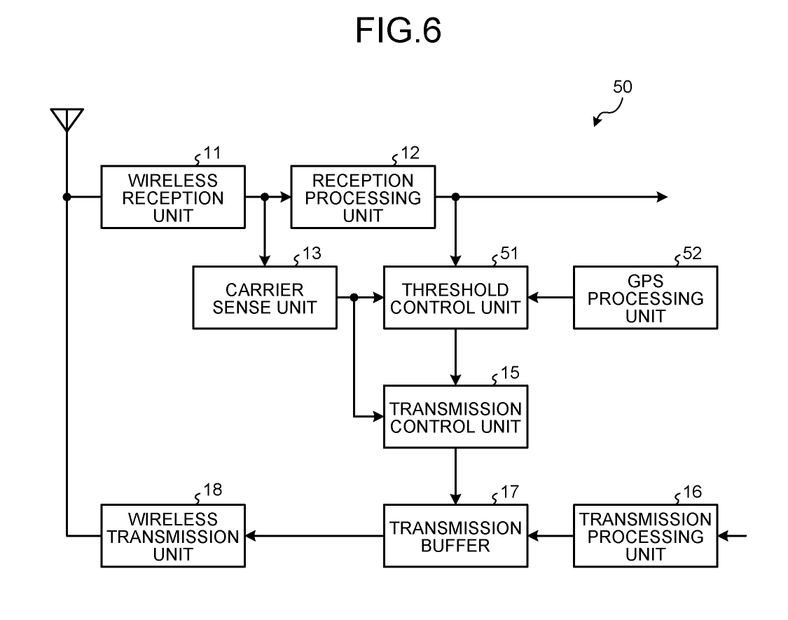

FIG. 6 is a block diagram illustrating an example of the wireless communication device of the second embodiment. In FIG. 6, the wireless communication device 50-2 includes a threshold control unit 51 and a global positioning system (GPS) processing unit 52. The wireless communication device 50-2 corresponds to the wireless communication device 10-2 of the first embodiment.

The threshold control unit 51 determines presence or absence of interference from the second wireless system based on “predetermined information” received from the wireless communication device 50-1 that is a different wireless communication device employing the first communication method. For example, the threshold control unit 51 determines presence or absence of interference based on “predetermined information”, which is included in a signal received from the reception processing unit 12 and which indicates a location of the base station 30 of the second wireless system located around the wireless communication device 10-1, and based on a location of the wireless communication device 50-2. For example, the threshold control unit 51 calculates a distance between the base station 30 and the wireless communication device 50-1, and determines that there is interference when the calculated distance is equal to or shorter than a predetermined distance.

When determining that there is interference, the threshold control unit 51 changes the busy threshold to the second set value. For example, when determining that there is interference, the threshold control unit 51 outputs a “set value change instruction” including the second set value to the transmission control unit 15.

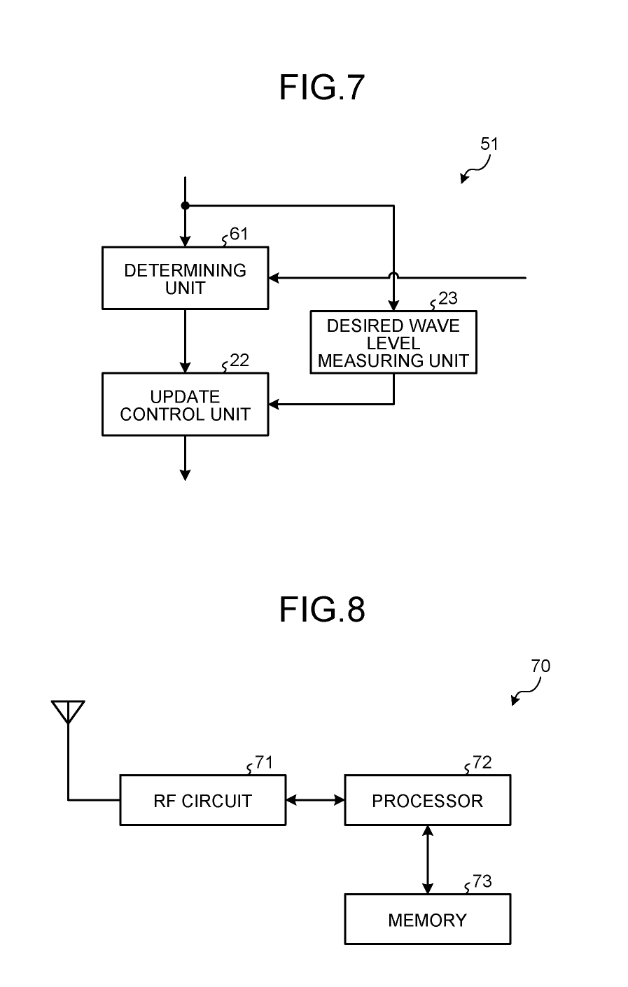

FIG. 7 is a block diagram illustrating an example of the threshold control unit of the second embodiment. In FIG. 7, the threshold control unit 51 includes a determining unit 61. The determining unit 61 calculates the above-described distance and determines that there is interference when the calculated distance is equal to or shorter than the predetermined distance.

The GPS processing unit 52 acquires location information on the location of the wireless communication device 50-2, and outputs the acquired location information to the threshold control unit 51.

As described above, according to the second embodiment, the determining unit 61 of the wireless communication device 50-2 determines presence or absence of interference from the second wireless system based on the “predetermined information” received from the wireless communication device 50-1 that is a different wireless communication device employing the first communication method. For example, the determining unit 61 determines presence or absence of interference based on the “predetermined information”, which is included in the signal received from the reception processing unit 12 and which indicates the location of the base station 30 of the second wireless system located around the wireless communication device 10-1, and based on the location of the wireless communication device 50-2. Then, when it is determined that there is interference, the update control unit 22 changes the busy threshold to the second set value.

With the configuration of the wireless communication device 50-2, the busy threshold can be increased when it is estimated that there is interference from the first communication system, and therefore, the wireless communication device 50-2 can easily start communication. Consequently, it becomes possible to prevent reduction of the throughput of the “first wireless system” without applying intermittent transmission to the “second wireless system”. Furthermore, it becomes possible to prevent reduction of the throughput of the “second wireless system” because intermittent transmission is not applied to the “second wireless system”. As a result, it becomes possible to reduce reduction of the throughput of the entire communication system 1.

Incidentally, the components of the units illustrated in the first embodiment and the second embodiment need not necessarily be physically configured in the manner illustrated in the drawings. In other words, specific forms of distribution and integration of the components are not limited to those illustrated in the drawings, and all or part of the components may be functionally or physically distributed or integrated in arbitrary units depending on various loads or use conditions.

Furthermore, for each processing function performed by each apparatus, all or any part of the processing function may be implemented on a central processing unit (CPU) (or a microcomputer, such as a micro processing unit (MPU) or a micro controller unit (MCU)). Moreover, for each processing function, all or any part of the processing function may be implemented by a program analyzed and executed by the CPU (or a microcomputer, such as an MPU or an MCU) or may be implemented by hardware by wired logic.

The wireless communication devices of the first embodiment and the second embodiment may be implemented by, for example, a hardware configuration as described below.

FIG. 8 is a diagram illustrating a hardware configuration example of the wireless communication device. As illustrated in FIG. 8, a wireless communication device 70 includes a radio frequency (RF) circuit 71, a processor 72, and a memory 73. Examples of the processor 72 include a CPU, a digital signal processor (DSP), and a field programmable gate array (FPGA). Furthermore, examples of the memory 73 include a random access memory (RAM), such as a synchronous dynamic random access memory (SDRAM), a read only memory (ROM), and a flash memory. Each of the wireless communication devices 10 and 50 of the first and the second embodiments has the hardware configuration as illustrated in FIG. 8.

Various processing functions implemented by the wireless communication devices of the first and the second embodiments may be implemented by causing a processor included in an amplifying device to execute a program stored in various memories, such as a non-volatile storage medium. That is, it may be possible to record, in the memory 73, programs corresponding to processes executed by the reception processing unit 12, the carrier sense unit 13, the threshold control units 14 and 51, the transmission control unit 15, and the transmission processing unit 16, and cause the processor 72 to execute each of the programs. Furthermore, the transmission buffer 17 is implemented by the memory 73. Moreover, the wireless reception unit 11 and the wireless transmission unit 18 are implemented by the RF circuit 71.

While it is explained that the single processor 72 executes various processing functions implemented by the wireless communication devices of the first and the second embodiments, it is not limited thereto, and the various processing functions may be executed by a plurality of processors.

### [c] Third Embodiment

A third embodiment and subsequent embodiments are embodiments in which reduction of the throughput of the communication system is prevented by modifying intermittent transmission of the second wireless system.

Overall Configuration Example of a Mobile Communication System

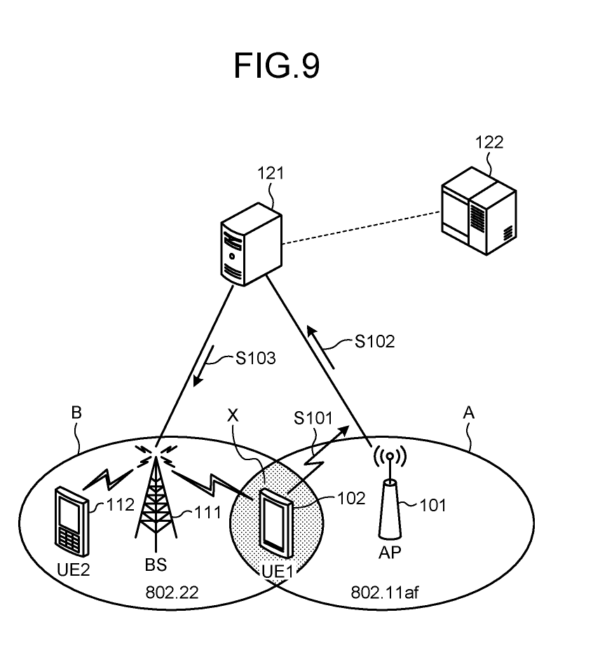

FIG. 9 is a diagram illustrating an overall configuration example of a mobile communication system according to the third embodiment. In FIG. 9, a state is illustrated in which two wireless systems that perform communications using the TVWS are mixed (they use the same frequency).

A first wireless system A performs carrier sense and then performs wireless communication between a base station device (a first base station, hereinafter, referred to as a base station AP) 101 and a mobile station device (hereinafter, referred to as a mobile station UE1) 102 by using a WLAN, in accordance with the communication standard of IEEE802.11af.

A second wireless system B performs wireless communication using cellular communication between a base station device (a second base station, hereinafter, referred to as a base station BS) 111 and a mobile station device (hereinafter, referred to as a mobile station UE2) 112, in accordance with the communication standard of IEEE802.22.

The communication standard of IEEE802.19.1 defines a method of arranging a coexistence manager (arbitration device) 121 that arbitrates a plurality of wireless systems when the wireless systems are mixed as described above. The arbitration device 121 controls assignment of channels or the like with respect to the base station (AP) 101 of the first wireless system A. Furthermore, the arbitration device 121 controls scheduling, intermittent transmission in which a no-transmission interval is periodically provided, or the like, with respect to the base station (BS) of the second wireless system B.

A database 122 is connected to the arbitration device 121. The database 122 manages channels available to the TVWS.

Incidentally, the first wireless system A may be replaced with a different WLAN system, and the second wireless system B may be replaced with a different cellular communication system, such as an LTE.

As illustrated in FIG. 9, it is assumed that an area of the first wireless system A and an area of the second wireless system B overlap each other, and an area X (an area indicated by oblique lines) in which the wireless systems A and B are mixed is provided. It is also assumed that the mobile station (UE1) 102 of the wireless system A is moved to and located in the area X. The initial state (normal state) of the wireless system B is a transmission state in which pieces of frame data are continuously transmitted (referred to as continuous transmission), rather than the intermittent transmission.

In the above-described state, the mobile station (UE1) 102 of the wireless system A detects a carrier at a level indicating that a different communication apparatus is performing communication, and enters a transmission wait state (busy state). That is, the mobile station (UE1) 102 receives a signal (signal sent by continuous transmission rather than the intermittent transmission) from the base station (BS) 111 of the wireless system B, and enters the busy state. If this state is continued, the mobile station (UE1) 102 located in the area X continues to remain in the state of being unable to perform transmission to the base station (AP) 101 of the wireless system A.

In the third embodiment, if the busy state of the mobile station (UE1) 102 is continued for a predetermined time, the mobile station (UE1) 102 transmits a signal for requesting a start of the intermittent transmission (an intermittent transmission request) to the base station (AP) 101 of the first wireless system A (Step S101).

Specifically, when the mobile station (UE1) 102 continuously detects the busy state for the predetermined time or longer, the mobile station (UE1) 102 temporarily stops control of the CSMA/CA, and transmits an intermittent transmission request signal to the base station (AP) 101. In addition, when the mobile station (UE1) 102 continuously detects the busy state for the predetermined time or longer, the mobile station (UE1) 102 may transmit the intermittent transmission request signal by using a no-transmission interval of the base station (BS) 111 of the second wireless system B, which will be described in detail in a fourth embodiment.

It is assumed that the signal transmitted by the mobile station (UE1) 102 has a size that is shorter than a data packet and that is small so as not to influence other communication (for example, interference to the second wireless system B).

The base station (AP) 101 that has received the intermittent transmission request from the mobile station (UE1) 102 requests the arbitration device 121, which is located in the upper layer in the system, to start intermittent transmission (Step S102). The arbitration device 121 requests the base station (BS) 111 of the second wireless system B to start the intermittent transmission (Step S103). In the example illustrated in the drawing, the base station (AP) 101, the arbitration device 121, and the base station (BS) 111 are connected by wire, but may be connected by wireless.

Furthermore, the base station (AP) 101 of the first wireless system A may directly request the base station (BS) 111 of the second wireless system B to start the intermittent transmission (intermittent transmission request) without via the arbitration device 121.

Upon receiving the intermittent transmission request, the base station (BS) 111 of the second wireless system B starts the intermittent transmission in which a no-transmission interval is periodically provided.

Accordingly, the mobile station (UE1) 102 of the first wireless system A can transmit a data packet to the base station (AP) 101 of the first wireless system A by using the no-transmission interval in the intermittent transmission of the second wireless system B, under the control of the CSMA/CA.

Thereafter, when receiving an intermittent transmission stop request from the first wireless system A or when not detecting communication by the first wireless system A in the no-transmission interval for a predetermined time, the base station (BS) 111 of the second wireless system B stops an intermittent transmission mode and returns to a continuous transmission mode.

Through the above-described control, the base station (BS) 111 of the second wireless system B can change the continuous transmission to the intermittent transmission in a period in which the mobile station (UE1) 102 of the first wireless system A is located in the area X. Consequently, it becomes possible to avoid interference with the mobile station (UE1) 102 when different types of wireless systems are mixed, and to prevent reduction of the throughput in the first wireless system A and the second wireless system B.

Configuration Example of the Base Station AP of the First Wireless System A

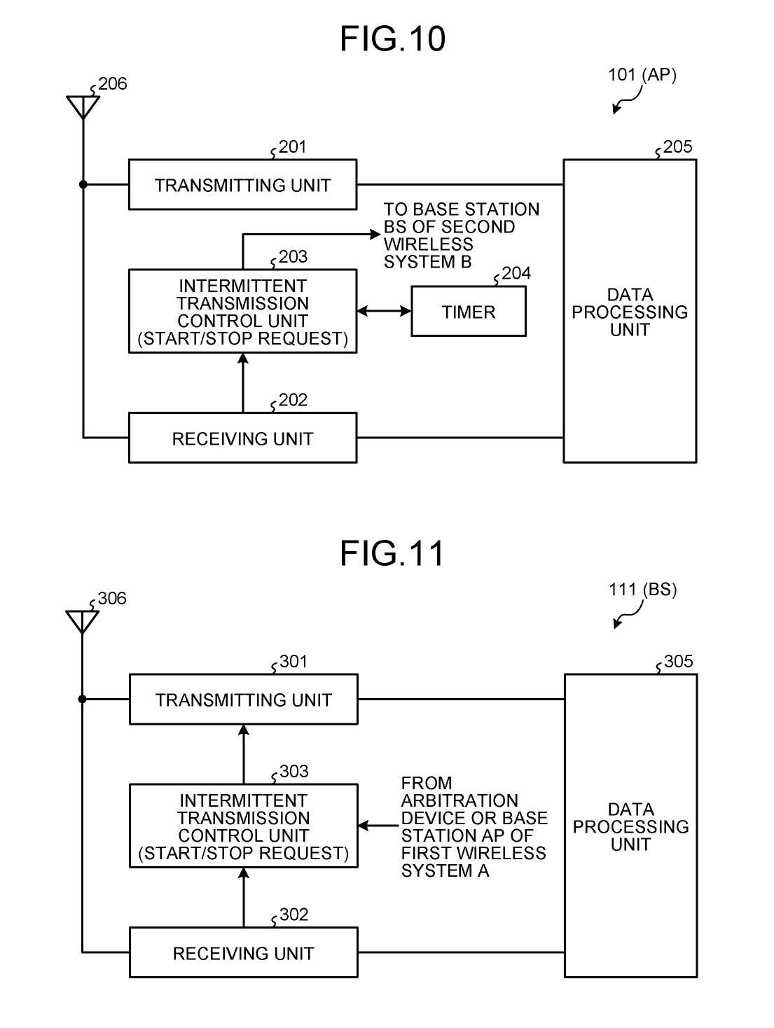

Next, each configuration example of the mobile communication system will be described. FIG. 10 is a block diagram illustrating a configuration example of the base station of the first wireless system. The base station (AP) 101 of the first wireless system A includes a transmitting unit 201, a receiving unit 202, an intermittent transmission control unit 203, a timer 204, a data processing unit 205, and an antenna 206.

The receiving unit 202 receives radio waves transmitted from the mobile station (UE1) 102 via the antenna 206, and outputs decoded data to the data processing unit 205. Furthermore, the receiving unit 202 outputs an intermittent transmission request in the received data to the intermittent transmission control unit 203.

The data processing unit 205 performs data processing on reception data, and performs a process of transferring the data to a transmission destination (for example, a different mobile station, a network server, or the like). Furthermore, the data processing unit 205 performs data processing on transmission data, which is transmitted from a different mobile station, a network server, or the like to the mobile station (UE1) 102 serving as a destination in the area of the base station (AP) 101, and outputs the processed data to the transmitting unit 201.

The transmitting unit 201 transmits the transmission data output from the data processing unit 205 to the mobile station (UE1) 102 via the antenna 206.

When receiving input of a signal of the intermittent transmission request from the mobile station (UE1) 102, the intermittent transmission control unit 203 sends the intermittent transmission request to the base station (BS) 111 of the second wireless system B and activates the timer 204 that measures a predetermined time.

Furthermore, the intermittent transmission control unit 203 transmits the intermittent transmission request to the base station (BS) 111 of the second wireless system B via the arbitration device 121. After the base station (BS) 111 performs the intermittent transmission, if communication by the mobile station (UE1) 102 is stopped for a predetermined time or longer (the timer 204 has counted up), the intermittent transmission control unit 203 determines that the intermittent transmission is not needed, and outputs a signal for stopping the intermittent transmission to the base station (BS) 111 of the second wireless system B. Consequently, the base station (BS) 111 can stop unnecessary intermittent transmission (can return to the continuous transmission), so that it becomes possible to prevent reduction of the throughput of the second wireless system B.

The above-described signal for the intermittent transmission request/stop is sent to the base station (BS) 111 of the second wireless system B from the base station (AP) 101, without through the arbitration device 121 (by wire) or through the arbitration device 121.

Configuration Example of the Base Station BS of the Second Wireless System B

FIG. 11 is a block diagram illustrating a configuration example of the base station of the second wireless system. The base station (BS) 111 of the second wireless system B includes a transmitting unit 301, a receiving unit 302, an intermittent transmission control unit 303, a data processing unit 305, and an antenna 306.

The receiving unit 302 receives radio waves transmitted from the mobile station (UE2) 112 via the antenna 306, and outputs decoded data to the data processing unit 305.

The data processing unit 305 performs data processing on reception data, and performs a process of transferring data to a transmission destination (for example, a different mobile station, a network server, or the like). Furthermore, the data processing unit 305 performs data processing on transmission data, which is transmitted from a different mobile station, a network server, or the like and which is transmitted to the mobile station (UE2) 112, as a destination, in the area of the base station (BS) 111, and outputs the processed data to the transmitting unit 301.

The transmitting unit 301 transmits the transmission data output from the data processing unit 305 to the mobile station (UE2) 112 via the antenna 306.

The intermittent transmission control unit 303, upon receiving a signal of the intermittent transmission request/stop transmitted from the arbitration device 121 or the base station (AP) 101 of the first wireless system A, controls transmission of the transmitting unit 301. The intermittent transmission control unit 303 changes transmission of the transmitting unit 301 from the continuous transmission to the intermittent transmission when receiving the signal of the intermittent transmission request, and changes the transmission from the intermittent transmission to the continuous transmission when receiving the signal of the intermittent transmission stop.

Configuration Example of the Mobile Station UE1 of the First Wireless System A

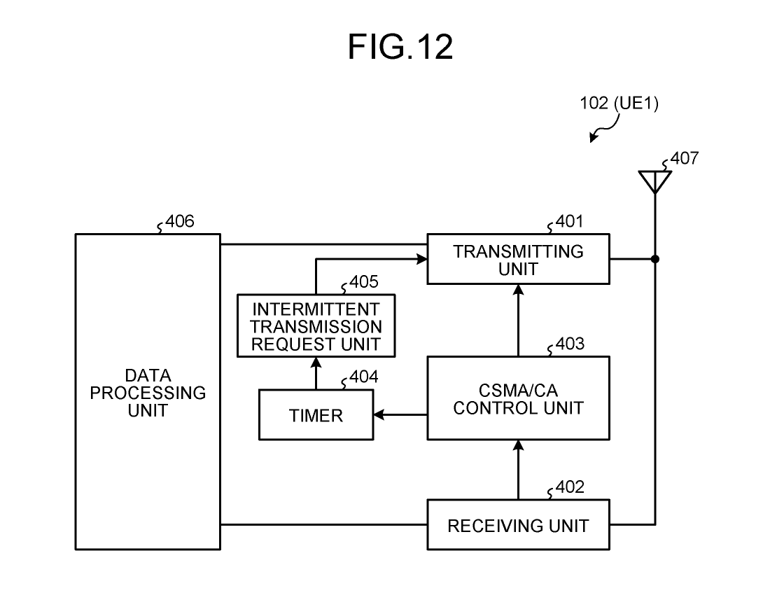

FIG. 12 is a block diagram illustrating a configuration example of the mobile station of the first wireless system. The mobile station (UE1) 102 of the first wireless system A includes a transmitting unit 401, a receiving unit 402, a CSMA/CA control unit 403, a timer 404, an intermittent transmission request unit 405, a data processing unit 406, and an antenna 407.

The receiving unit 402 receives radio waves transmitted from the base station (AP) 101 via the antenna 407, outputs decoded data to the data processing unit 406, and sends a signal indicating that the decoding has been successful to the CSMA/CA control unit 403 or sends a detected radio-wave level to the CSMA/CA control unit 403 when the decoding has failed.

The data processing unit 406 performs data processing on reception data, and outputs the data to an application or the like in the mobile station (UE1) 102. Furthermore, the data processing unit 406 performs data processing on transmission data, which is received from an application or the like and which is transmitted to a different mobile station (UE), a network server, or the like as a destination, and outputs the processed data to the transmitting unit 401.

The transmitting unit 401 transmits the transmission data output from the data processing unit 406 to the base station (AP) 101 via the antenna 407.

If the CSMA/CA control unit 403 receives a signal indicating that the decoding has been successful from the receiving unit 402 or if the radio-wave level from the receiving unit 402 is equal to or higher than a predetermined level, the CSMA/CA control unit 403 determines that communication exists and controls the transmitting unit 401 so as not to perform transmission. Furthermore, if the radio-wave level from the receiving unit 402 is lower than the predetermined level, the CSMA/CA control unit 403 determines that communication does not exist, and controls the transmitting unit 401 so as to perform transmission in an interval in which no communication is detected.

If the CSMA/CA control unit 403 determines that communication exists and the state in which the communication exists is continued longer than a predetermined time, the timer 404 detects a busy state. The timer 404 indicates the busy state due to radio waves from the second wireless system B (at the time of continuous transmission) when the mobile station (UE1) 102 is located in the area X. For example, when the busy state, in which transmission is not possible for a predetermined time or longer, is detected, and when it is determined that a system performing transmission is not the wireless system A, the timer 404 determines that the intermittent transmission request is needed and instructs the intermittent transmission request unit 405 to request transmission. Determination on whether the system performing transmission is the wireless system A may be performed based on control information on the decoded data from the receiving unit 402.

The intermittent transmission request unit 405, upon receiving an instruction indicating a need of the intermittent transmission request from the timer 404, outputs a signal of the intermittent transmission request. In this case, the intermittent transmission request unit 405 causes the transmitting unit 401 to suspend transmission of a signal of the CSMA/CA to stop transmission of the signal of the intermittent transmission request. The signal of the intermittent transmission request is sent to the base station (BS) 111 of the second wireless system B as described above.

Each of the base station (AP) 101, the base station (BS) 111, and the mobile station (UE1) 102 as described above includes a CPU and a memory, such as a ROM or a RAM. The CPU executes a program stored in the ROM and uses the RAM as a work area to control operations.

For example, the base station (AP) 101 illustrated in FIG. 10 can obtain the functions of the data processing unit 205, the intermittent transmission control unit 203, and the timer 204, except for the transmitting unit 201 and the receiving unit 202, by causing the CPU to execute the program. The same as the base station (AP) 101 is applied to the base station (BS) 111 illustrated in FIG. 11.

Furthermore, the mobile station (UE1) 102 illustrated in FIG. 12 can obtain the functions of the data processing unit 406, the CSMA/CA control unit 403, the timer 404, and the intermittent transmission request unit 405, except for the transmitting unit 401 and the receiving unit 402, by causing the CPU to execute the program.

Example of an Operation Performed by the Mobile Communication System

Example of a Process Performed by the Mobile Station UE1 of the First Wireless System A

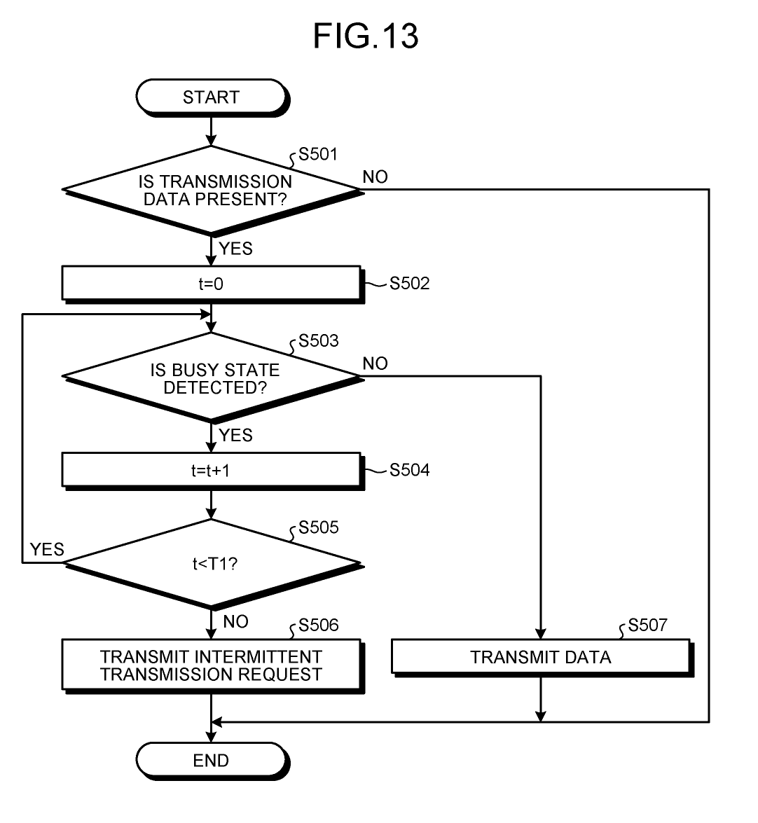

FIG. 13 is a flowchart illustrating an example of a process performed by the mobile station of the first wireless system. A process performed by the intermittent transmission request unit 405 of the mobile station (UE1) 102 of the first wireless system A is mainly illustrated.

First, the mobile station (UE1) 102 determines whether transmission data to the base station (AP) 101 is present (Step S501). If the transmission data is not present (NO at Step S501), the process ends. If the transmission data is present (YES at Step S501), a count value t of the timer is set to an initial value of zero (Step S502).

Subsequently, the mobile station (UE1) 102 determines whether the busy state is detected (Step S503). If the busy state is detected (YES at Step S503), the count value t of the timer is incremented (Step S504), and is compared with a predetermined count-up value (predetermined period) T1 (Step S505). The count-up value T1 is, for example, a period for detecting the need of the intermittent transmission request (a few seconds to a few minutes). The count-up value T1 is set to a value corresponding to time out of data transmission.

If the count value t of the timer is smaller than the count-up value T1 (YES at Step S505), the process returns to Step S503 and the mobile station (UE1) 102 continues to detect the busy state. In contrast, if the count value t of the timer is equal to or greater than the count-up value T1 (NO at Step S505), the mobile station (UE1) 102 determines that the busy state is continued for the predetermined period T1. Then, the mobile station (UE1) 102 transmits the signal of the intermittent transmission request (Step S506), and the process ends. The signal of the intermittent transmission request is sent to the base station (BS) 111 of the second wireless system B as described above.

Furthermore, at Step S503, if the busy state is not detected (NO at Step S503), the mobile station (UE1) 102 transmits data to the base station (AP) 101 of the first wireless system A under normal control (CSMA/CA) (Step S507). Thus, a series of the process is completed.

The mobile station (UE1) 102 transmits the signal of the intermittent transmission request to the base station (AP) 101, but does not transmit the signal of the intermittent transmission stop. Therefore, the mobile station (UE1) 102 can send the intermittent transmission request to the base station (AP) 101 with the minimum information without transmitting unnecessary radio waves, so that it is possible to prevent the mobile station (UE1) 102 from causing interference. Incidentally, as described above, to stop the intermittent transmission after the intermittent transmission, the base station (AP) 101 may send a request to the base station (BS) 111 through the arbitration device 121 or directly (by wire without through the arbitration device 121), or the base station (BS) 111 of the second wireless system B directly controls the stop.

Example of a Format of the Signal of the Intermittent Transmission Request

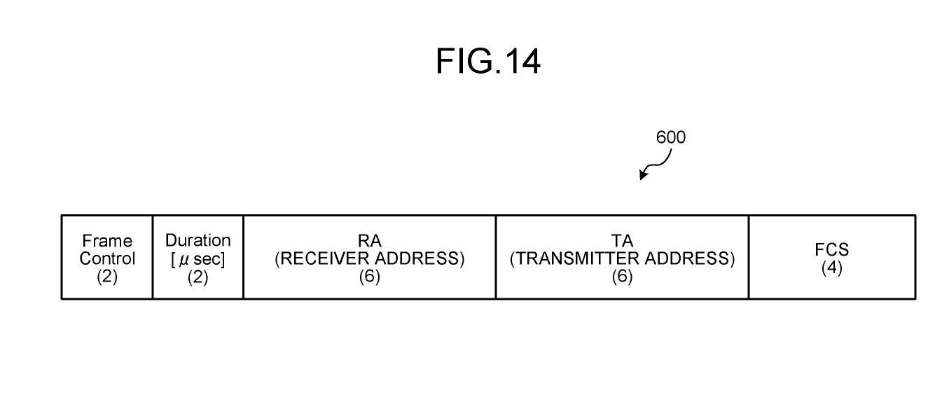

FIG. 14 is a diagram illustrating an example of the format of the signal of the intermittent transmission request. It is sufficient that the signal of the intermittent transmission request transmitted by the mobile station (UE1) 102 of the first wireless system A has a size that is smaller than a size of a data packet and is small so as not to influence other communication (the second wireless system B).

For example, as illustrated in FIG. 14, it is possible to use a format of a general-purpose Request to Send/Clear to Send (RTS/CTS) packet 600, which is introduced to cope with a problem with a hidden node or an exposed node. The RTS/CTS packet 600 has fields such as frame information (Frame Control), frame transmission duration (Duration), RA (receiver address), TA (transmitter address), and frame check information (frame check sequence (FCS)). Numerals in the drawing indicate a size with a unit of octet.

In the normal RTS/CTS, a value equal to or greater than 1 is applied in the field of Duration. When the value is set to zero, it is interpreted that the signal is a signal of the intermittent transmission request, and the signal is transmitted and received.

Furthermore, it may be possible to indicate the intermittent transmission request by using a reserved bit in Type and Subtype of the field of Frame Control. In this case, a payload is not needed, so that by transmitting a packet including only the field of Frame Control, it is possible to reduce the size of the signal of the intermittent transmission request to below a data packet having a payload.

Example of a Process Performed by the Base Station AP of the First Wireless System A

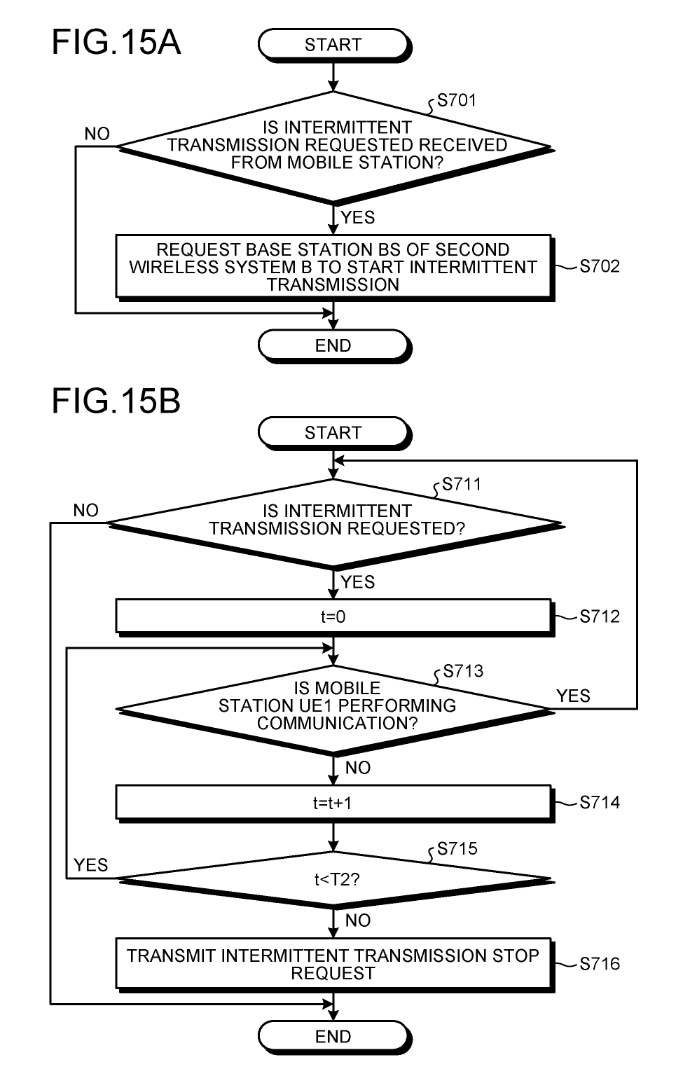

FIG. 15A is a flowchart illustrating an example of a process on the intermittent transmission request by the base station of the first wireless system. A process performed by the intermittent transmission control unit 203 of the base station (AP) 101 of the first wireless system A is mainly illustrated.

First, the base station (AP) 101 determines whether the signal of the intermittent transmission request is received from the mobile station (UE1) 102 (Step S701). If the intermittent transmission request is not received (NO at Step S701), the process ends. If the intermittent transmission request is received (YES at Step S701), the base station (AP) 101 requests the base station (BS) 111 of the second wireless system B to start intermittent transmission (intermittent transmission request) (Step S702), and the process ends.

FIG. 15B is a flowchart illustrating an example of a process on the intermittent transmission stop request by the base station of the first wireless system. A process performed by the intermittent transmission control unit 203 of the base station (AP) 101 of the first wireless system A is mainly illustrated.

First, the base station (AP) 101 determines whether the intermittent transmission request is already transmitted to the base station (BS) 111 of the second wireless system B (Step S711). If the intermittent transmission request is not yet transmitted to the second wireless system B (NO at Step S711), the base station (AP) 101 ends the process. If the intermittent transmission request is already transmitted (YES at Step S711), the base station (AP) 101 sets the count value t of the timer 204 to the initial value of zero (Step S712), and determines whether the mobile station (UE1) 102 is communicating with the base station (AP) 101 (Step S713).

If the mobile station (UE1) 102 is performing communication (YES at Step S713), the processing step returns to Step S711. In contrast, if the mobile station (UE1) 102 is not performing communication (NO at Step S713), the mobile station (UE1) 102 increments the count value t of the timer 204 (Step S714), and compares the count value t and a predetermined count-up value T2 (Step S715). The count-up value T2 is set to, for example, a value corresponding to a case in which the mobile station (UE1) 102 ends the communication and continues to stop communication (for example, 10 minutes).

If the count value t of the timer is smaller than the count-up value T2 (YES at Step S715), the processing step returns to Step S713, and a process, which is performed when the mobile station (UE1) 102 is in a non-communication state, is continued. In contrast, if the count value t of the timer is equal to or greater than the count-up value T2 (NO at Step S715), the base station (AP) 101 determines that the communication is terminated because the mobile station (UE1) 102 is continuously in the non-communication state during the period T2, and transmits the signal of the intermittent transmission stop through the arbitration device 121 or directly (by wire without through the arbitration device 121) (Step S716). The signal of the intermittent transmission stop is sent to the base station (BS) 111 of the second wireless system B as described above.

Example of a Process Performed by the Base Station BS of the Second Wireless System B

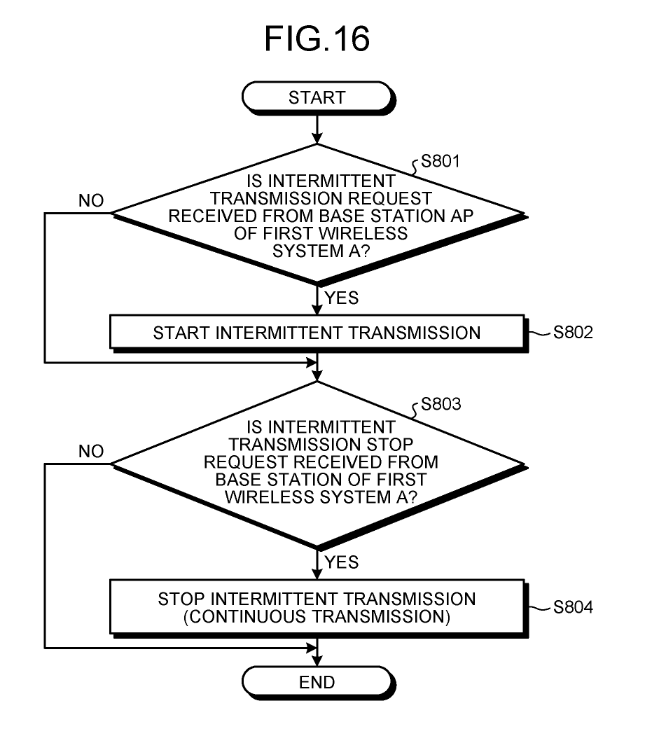

FIG. 16 is a flowchart illustrating an example of a process performed by the base station of the second wireless system. A process performed by the intermittent transmission control unit 303 of the base station (BS) 111 of the second wireless system B is mainly illustrated. The base station (BS) 111 communicates with the mobile station (UE2) 112.

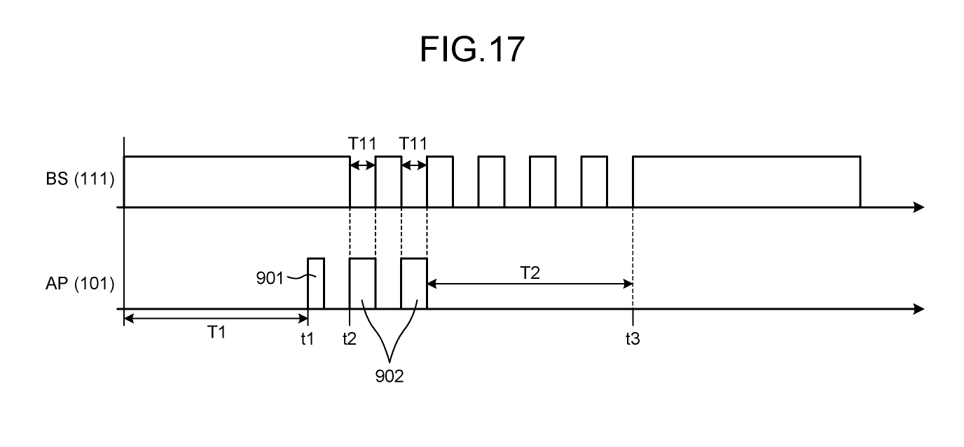

First, the base station (BS) 111 determines whether the signal of the intermittent transmission request is received from the first wireless system A (the base station (AP) 101) (Step S801). If the intermittent transmission request is not received (NO at Step S801), the process proceeds to Step S803. If the intermittent transmission request is received (YES at Step S801), intermittent transmission including a periodic no-transmission interval T11 (see FIG. 17) is started (Step S802).

Thereafter, the base station (BS) 111 determines whether the signal of the intermittent transmission stop is received from the first wireless system A (the base station (AP) 101) (Step S803). If the intermittent transmission stop request is not received (NO at Step S803), the base station (BS) 111 ends the process. In contrast, if the intermittent transmission stop request is received (YES at Step S803), the base station (BS) 111 stops the intermittent transmission (changes to the continuous transmission) (Step S804).

Explanation of a Timing to Control the Intermittent Transmission

FIG. 17 is a timing diagram for explaining control of intermittent transmission according to the third embodiment. The horizontal axis represents time, an upper part of the vertical axis represents the base station (BS) 111 of the second wireless system B, and a lower part of the vertical axis represents the base station (AP) 101 of the first wireless system A.

The mobile station (UE1) 102 of the first wireless system A is located in the area X, and upon detecting the busy state for the predetermined time T1, transmits an intermittent transmission request 901 (a time t1). Accordingly, the second wireless system B (the base station (BS) 111) starts intermittent transmission including periodic no-transmission intervals T11.

Consequently, the mobile station (UE1) 102 of the first wireless system A can transmit data 902 to the base station (AP) 101 of the first wireless system A by using the periodic no-transmission intervals T11 after the second wireless system B (the base station (BS) 111) starts the intermittent transmission (a time t2).

Thereafter, the base station (AP) 101 of the first wireless system A starts counting by the timer to detect termination of data transmission from the mobile station (UE1) 102. If communication is not performed for the predetermined time T2 since previous communication, the base station (AP) 101 determines that the communication is terminated (a time t3), and transmits the intermittent transmission stop request to the second wireless system B (the base station (BS) 111). After the time t3, the second wireless system B (the base station (BS) 111) stops the intermittent transmission and switches (returns) to the continuous transmission.

According to the above-described third embodiment, the mobile station (UE1) 102 of the first wireless system A outputs the intermittent transmission request when a period in which communication with the base station (AP) 101 is not possible reaches the predetermined period T1. Upon receiving the intermittent transmission request, the second wireless system B starts the intermittent transmission. The mobile station (UE1) 102 of the first wireless system A can transmit data to the base station (AP) 101 by using the no-transmission intervals of the intermittent transmission of the second wireless system B.

Consequently, when the mobile station (UE1) 102 of the wireless system A is located in the area X in which the wireless systems A and B overlap each other, it is possible to perform communication while avoiding interference from the wireless system B. That is, it is possible to prevent the mobile station (UE1) 102 from continuing to remain in the busy state in which transmission is not possible, so that it is possible to improve the throughput of the wireless system A.

Furthermore, the wireless system B efficiently controls transmission intervals by performing the intermittent transmission only in the period in which the mobile station (UE1) that may cause interference is located in the area X, and by stopping the intermittent transmission (switches to the continuous transmission) when the mobile station (UE1) stops communication. Consequently, the intermittent transmission does not continue for more than needed even for the wireless system B, so that it is possible to minimize reduction of the throughput.

Incidentally, the mobile communication system of the third embodiment includes the base station 101 and the base station 111 that use different wireless communication systems and the same frequency band, and include the mobile station 102 that starts to communicate with the base station 101 after detecting presence or absence of transmission before the communication. The base station 111 includes the intermittent transmission control unit 303 that starts transmission with a no-transmission interval, based on the intermittent transmission request. The mobile station 102 includes the intermittent transmission request unit 405 that transmits the intermittent transmission request to the base station 111 when a state in which transmission is impossible due to continuous transmission by the base station 111 is continued for a predetermined period, and includes the transmitting unit 401 that transmits data in the no-transmission interval.

Furthermore, the base station 101 receives the intermittent transmission request from the mobile station 102, and transmits the intermittent transmission request to the base station 111 through the arbitration device 121 or directly.

Moreover, when communication with the mobile station 102 is continuously stopped for a predetermined time, the base station 101 transmits the intermittent transmission stop request to the base station 111.

Furthermore, the mobile station 102 transmits the intermittent transmission request by a packet with a size smaller than a data packet used in communication with the base station 101.

### [d] Fourth Embodiment

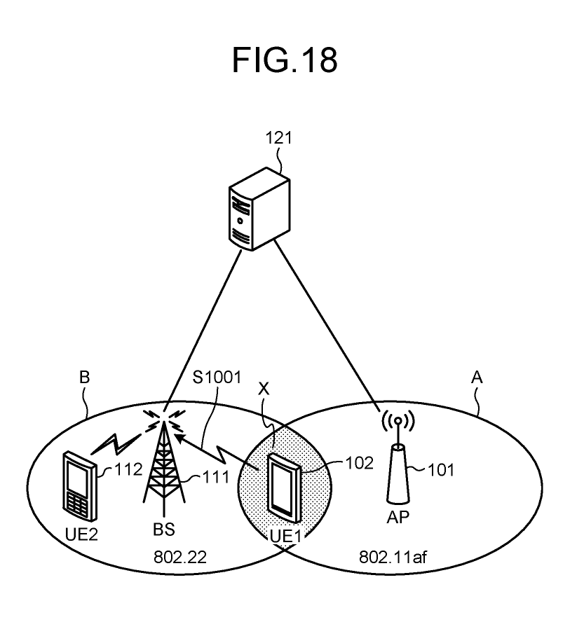

FIG. 18 is a diagram illustrating an overall configuration example of a mobile communication system of a fourth embodiment. In the fourth embodiment, the same components as those of the third embodiment are denoted by the same symbols.

In the fourth embodiment, the intermittent transmission request unit 405 of the mobile station (UE1) 102 of the first wireless system A directly transmits an intermittent transmission request 51001 to the base station (BS) 111 of the second wireless system B through the transmitting unit 401. That is, the mobile station (UE1) 102 of the first wireless system A located in the area X directly transmits a signal of the intermittent transmission request 51001 to the base station (BS) 111 of the second wireless system B without through the base station (AP) 101 and the arbitration device 121.

In the fourth embodiment, continuous transmission as in the third embodiment is not performed in the initial state (normal state), but a short no-transmission interval is provided. Therefore, the mobile station (UE1) 102 of the first wireless system A located in the area X can temporarily perform communication without interference from the second wireless system B for a time corresponding to the no-transmission interval. This communication is used for the intermittent transmission request.

Explanation of a Timing to Control the Intermittent Transmission

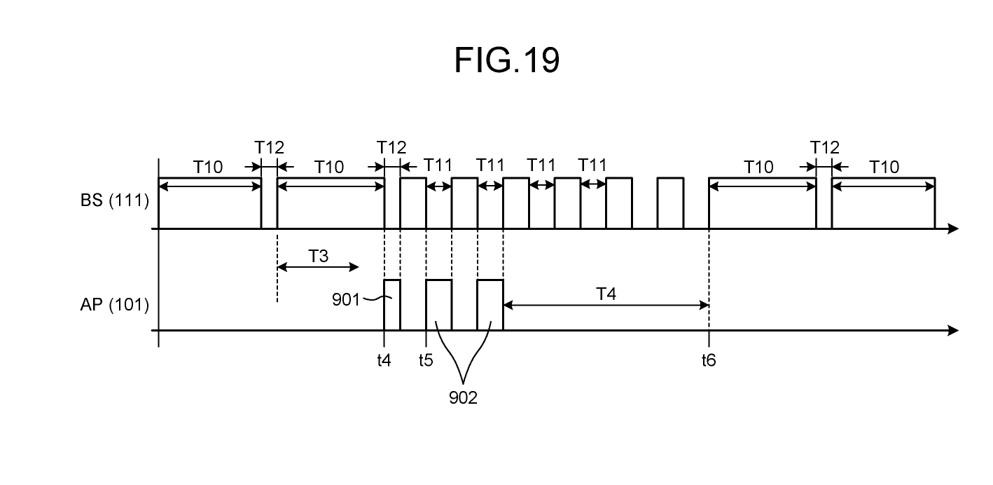

FIG. 19 is a timing diagram for explaining control of intermittent transmission according to the fourth embodiment. In the fourth embodiment, it is assumed that the base station (BS) 111 of the second wireless system B does not perform continuous transmission in the initial state (normal state), but a short no-transmission interval T12 of a few milliseconds or the like is provided for each long period (communication interval T10) of a few seconds or a few minutes.

If the mobile station (UE1) 102 of the first wireless system A is located in the area X and the busy state is continued for a predetermined period T3, the mobile station (UE1) 102 transmits a signal of the intermittent transmission request 901 by using the next short no-transmission interval T12 (a time t4).

It is assumed that the signal of the intermittent transmission request 901 transmitted by the mobile station (UE1) 102 is a packet (for example, RTS/CTS), which is short in time such that other communication (the second wireless system B) is not influenced by interference similarly to the third embodiment.

The base station (BS) 111 of the second wireless system B that has received the intermittent transmission request 901 starts intermittent transmission in which a periodic no-transmission interval T11 is provided (a time t5).

Consequently, the mobile station (UE1) 102 of the first wireless system A can transmit the data 902 to the base station (AP) 101 of the first wireless system A by using the periodic no-transmission intervals T11 after the second wireless system B (the base station (BS) 111) starts the intermittent transmission (a time t5).

Thereafter, the second wireless system B (the base station (BS) 111) monitors communication between the mobile station (UE1) 102 of the first wireless system A and the base station (AP) 101. If the communication with the mobile station (UE1) 102 is not continued for the predetermined time T4, the second wireless system B (the base station (BS) 111) stops the intermittent transmission (a time t6), and returns to the initial state (a state in which the short no-transmission interval T12 is provided for each of the long periods T10 of a few seconds or a few minutes).

Configuration Example of the Base Station AP of the First Wireless System A

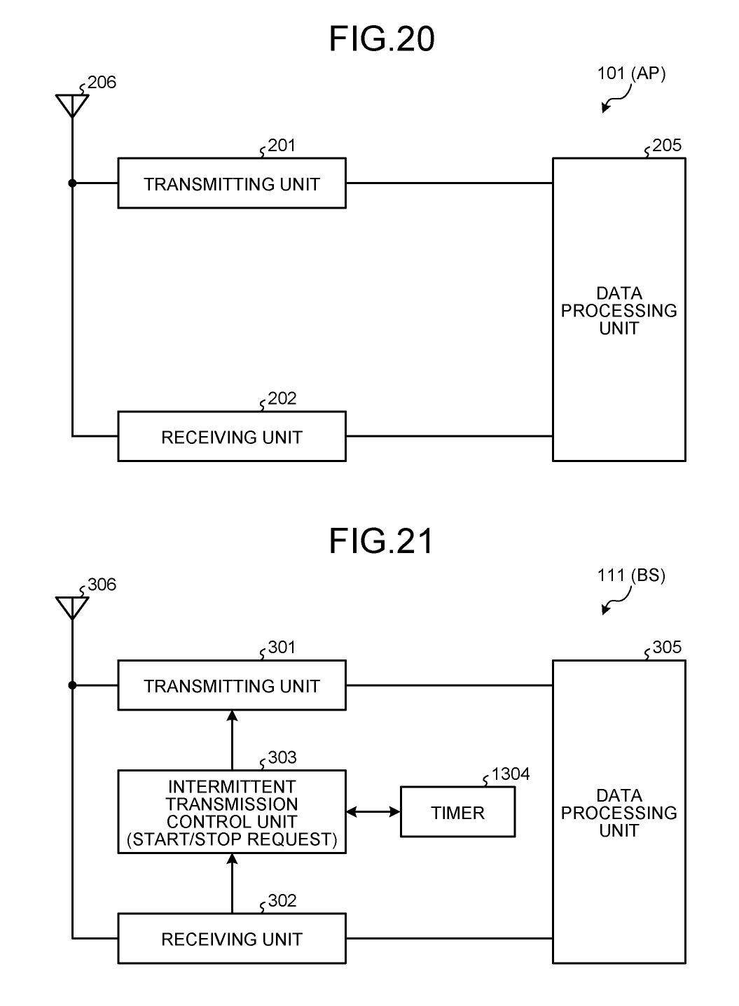

Next, each configuration example of the mobile communication system will be described. FIG. 20 is a block diagram illustrating a configuration example of the base station of the first wireless system. The base station (AP) 101 of the first wireless system A includes the transmitting unit 201, the receiving unit 202, the data processing unit 205, and the antenna 206.

In the fourth embodiment, the mobile station (UE1) 102 of the first wireless system A directly transmits the intermittent transmission request 51001 to the base station (BS) 111 of the second wireless system B. Therefore, the base station (AP) 101 of the first wireless system A need not include the intermittent transmission control unit 203 and the timer 204 illustrated in the third embodiment (see FIG. 10). That is, a general-purpose base station (AP) can be used as the base station (AP) 101 of the fourth embodiment.

Configuration Example of the Base Station BS of the Second Wireless System B

FIG. 21 is a block diagram illustrating a configuration example of the base station of the second wireless system. The base station (BS) 111 of the second wireless system B includes the transmitting unit 301, the receiving unit 302, the intermittent transmission control unit 303, a timer 1304, the data processing unit 305, and the antenna 306.

The receiving unit 302 receives the intermittent transmission request 51001 transmitted by the mobile station (UE1) 102 of the first wireless system A, and outputs the received request to the intermittent transmission control unit 303. The intermittent transmission control unit 303 does not perform continuous transmission in the initial state, but provides the short no-transmission interval T12 of a few milliseconds or the like for each long period (the communication interval T10) of a few seconds or a few minutes.

The timer 1304 measures an elapsed time of a non-communication state since previous communication of the mobile station (UE1) 102 of the first wireless system A, and counts up when the time reaches a predetermined count-up value T4. The count-up value T4 is set to a value corresponding to a case in which the mobile station (UE1) 102 ends the communication and continues to stop (corresponding to a time, for example, 10 minutes, in which the mobile station has exited the area X where interference has occurred).

When the timer 1304 counts up, the intermittent transmission control unit 303 determines that the communication is terminated because the mobile station (UE1) 102 is continuously in the non-communication state during the period T4, and then the intermittent transmission control unit 303 stops the intermittent transmission and returns to the initial state (a state in which the short no-transmission interval T12 is provided for each long period (the transmission interval T10) of a few seconds or a few minutes).

Configuration Example of the Mobile Station UE1 of the First Wireless System A

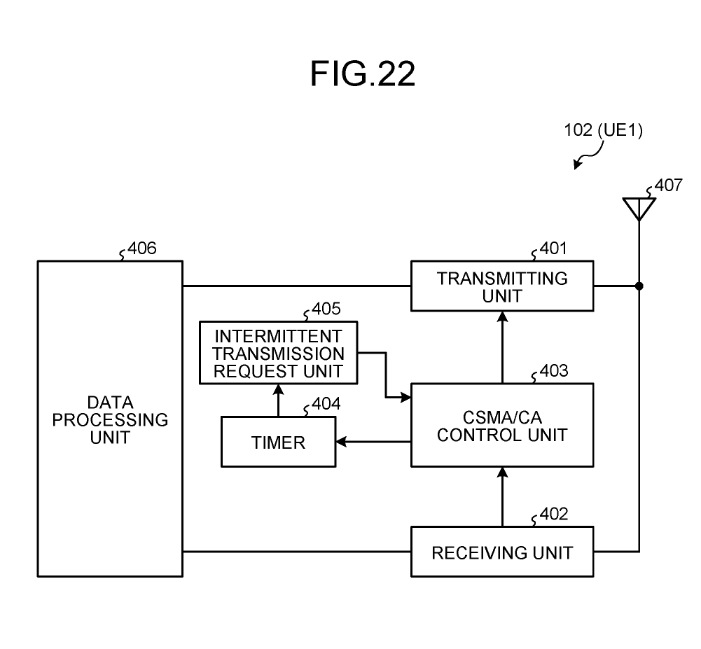

FIG. 22 is a block diagram illustrating a configuration example of the mobile station of the first wireless system. The mobile station (UE1) 102 of the first wireless system A includes the transmitting unit 401, the receiving unit 402, the CSMA/CA control unit 403, the timer 404, the intermittent transmission request unit 405, the data processing unit 406, and the antenna 407.

In the fourth embodiment, a configuration of the intermittent transmission request unit 405 is different from that of the third embodiment (see FIG. 12). The intermittent transmission request unit 405 outputs the signal of the intermittent transmission request 51001 when detecting the busy state for the predetermined period T2 through the measurement by the timer 404. In this case, the intermittent transmission request unit 405 causes the CSMA/CA control unit 403 to transmit the signal of the intermittent transmission request 51001 to the base station (BS) 111 of the second wireless system B in the no-transmission interval T12.

The mobile station (UE1) 102 of the fourth embodiment need not use a packet of a special frame as described in the third embodiment (see FIG. 14). If the base station (BS) 111 of the second wireless system B can receive the signal of the intermittent transmission request itself within a predetermined time range (the no-transmission interval T12), the base station (BS) 111 determines that the signal is the intermittent transmission request from the mobile station (UE1) 102.

Example of an Operation Performed by the Mobile Communication System

Example of a Process Performed by the Mobile Station UE1 of the First Wireless System A

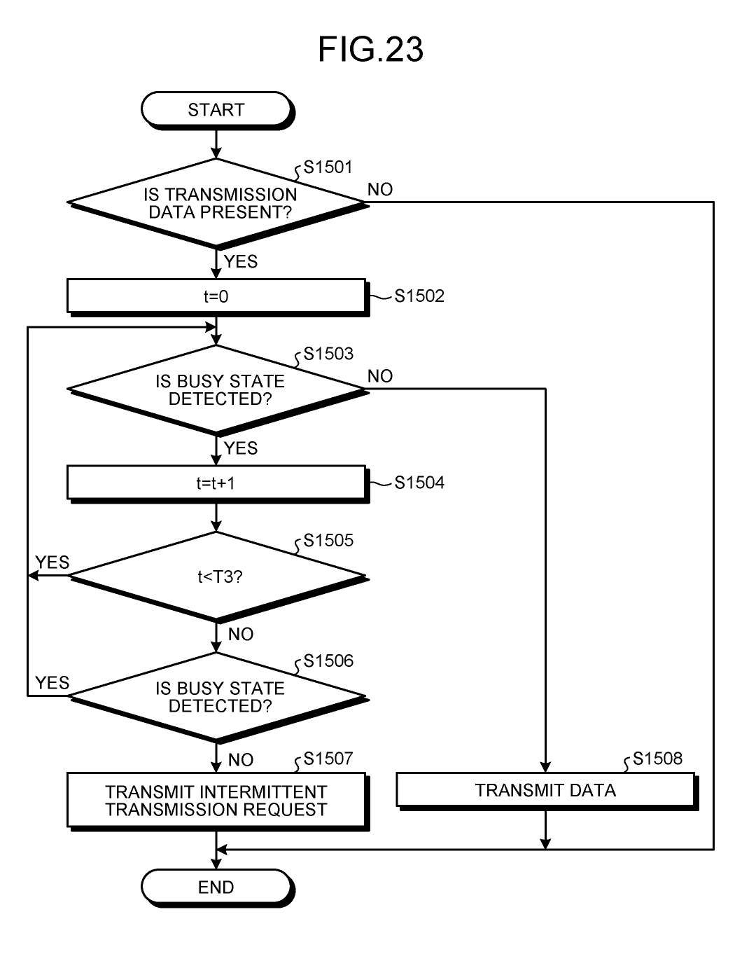

FIG. 23 is a flowchart illustrating an example of a process performed by the mobile station of the first wireless system. A process performed by the intermittent transmission request unit 405 of the mobile station (UE1) 102 of the first wireless system A is mainly illustrated.

First, the mobile station (UE1) 102 determines whether transmission data to the base station (AP) 101 is present (Step S1501). If the transmission data is not present (NO at Step S1501), the flow of the process ends. If the transmission data is present (YES at Step S1501), the count value t of the timer is set to the initial value of zero (Step S1502).

Subsequently, the mobile station (UE1) 102 detects whether the busy state is detected (Step S1503). If the busy state is detected (YES at Step S1503), the count value t of the timer is incremented (Step S1504), and is compared with a predetermined count-up value T3 (Step S1505). The count-up value T3 is, for example, a period for determining the busy state (a few seconds to a few minutes). The count-up value T3 is set to a value corresponding to time out of data transmission.

If the count value t of the timer is smaller than the count-up value T3 (YES at Step S1505), the process returns to Step S1503 and the mobile station (UE1) 102 continues to detect the busy state. In contrast, if the count value t of the timer is equal to or greater than the count-up value T3 (NO at Step S1505), the mobile station (UE1) 102 determines whether the busy state is detected again (Step S1506).

If the busy state is detected (YES at Step S1506), the processing step returns to Step S1503. In contrast, if the busy state is not detected (NO at Step S1506), the mobile station (UE1) 102 transmits the signal of the intermittent transmission request (Step S1507), and the process ends. The signal of the intermittent transmission request is directly transmitted to the base station (BS) 111 of the second wireless system B as described above.

Furthermore, if the busy state is not detected (NO at Step S1503), the mobile station (UE1) 102 transmits data to the base station (AP) 101 of the first wireless system A under normal control (CSMA/CA) (Step S1508). Thus, a series of the process is completed.

Example of a Process Performed by the Base Station BS of the Second Wireless System B

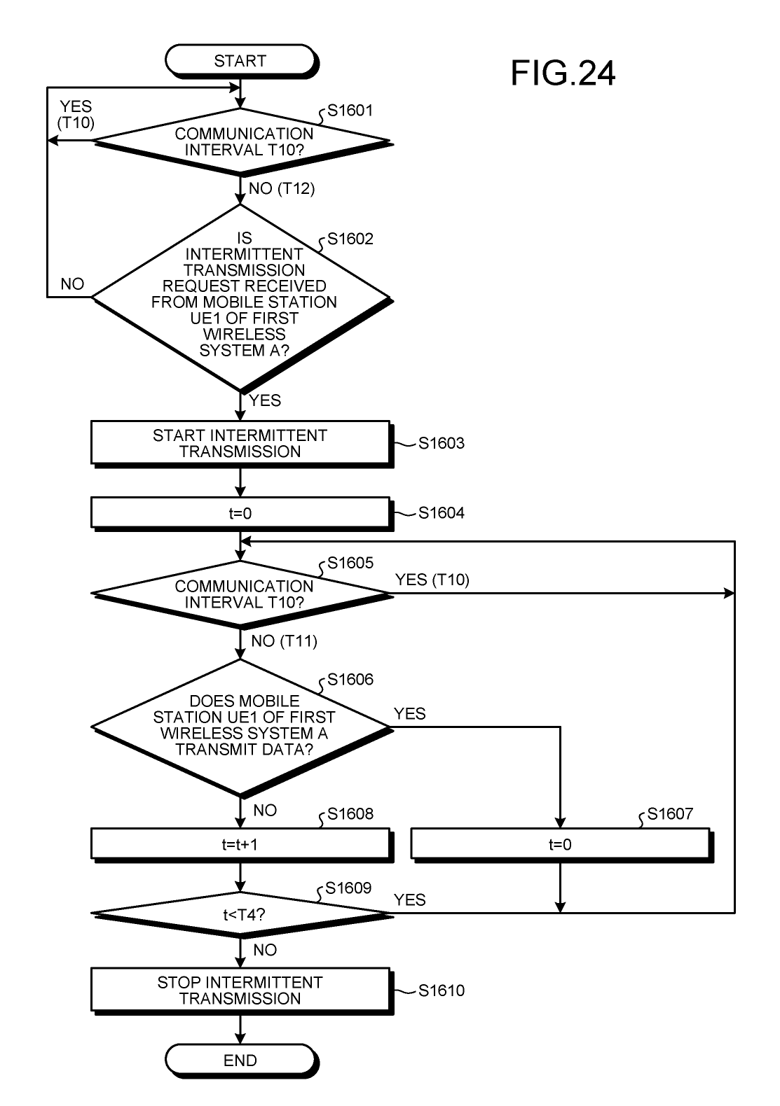

FIG. 24 is a flowchart illustrating an example of a process performed by the base station of the second wireless system. A process performed by the intermittent transmission control unit 303 of the base station (BS) 111 of the second wireless system B is mainly illustrated. The base station (BS) 111 communicates with the mobile station (UE2) 112 of the second wireless system B, and directly receives the intermittent transmission request 51001 from the mobile station (UE1) 102 when the mobile station (UE1) 102 of the first wireless system A is located in an area X.

The base station (BS) 111 does not perform continuous transmission in the initial state, but performs transmission in which the short no-transmission interval T12 of a few milliseconds or the like is provided for each long period (the communication interval T10) (Step S1601).

The base station (BS) 111 waits if the communication interval T10 is currently applied (a loop in the case of YES at Step S1601). If the communication interval T10 is not currently applied (in the no-transmission interval T12, NO at Step S1601), the base station (BS) 111 determines whether an intermittent transmission request is received from the mobile station (UE1) 102 of the first wireless system A during the no-transmission interval T12 (Step S1602).

If the intermittent transmission request is not received (NO at Step S1602), the processing step returns to Step S1601. In contrast, if the intermittent transmission request is received (YES at Step S1602), the base station (BS) 111 starts intermittent transmission including the periodic no-transmission interval T11 (Step S1603).

As described above, the mobile station (UE1) 102 of the fourth embodiment does not use a packet of a special frame as described in the third embodiment (see FIG. 14). Therefore, the base station (BS) 111 of the second wireless system B need not decode the signal of the intermittent transmission request, and can determine that the signal is the intermittent transmission request from the mobile station (UE1) 102 if the signal is received within a predetermined time range (the no-transmission interval T12). Therefore, it is possible to simplify the process.

The mobile station (UE1) 102 of the first wireless system A can transmit data to the base station (AP) 101 of the first wireless system A during the no-transmission interval T11.

Thereafter, the base station (BS) 111 starts the intermittent transmission, sets the count value t of the timer 1304 to the initial value of zero (Step S1604), and determines whether the mobile station (UE1) 102 is communicating with the base station (AP) 101.

Specifically, the base station (BS) 111 waits without performing a process in the period of the communication interval T10 (a loop in the case of YES at Step S1605). In contrast, in the case of a period other than the communication interval T10 (in the no-transmission interval T11, NO at Step S1605), the base station (BS) 111 monitors whether the mobile station (UE1) 102 of the first wireless system A transmits data during the no-transmission interval T11 (Step S1606).

If the mobile station (UE1) 102 transmits data (YES at Step S1606), the base station (BS) 111 resets the count value t of the timer 1304 to zero (Step S1607). Then, the processing step returns to Step S1605. In contrast, if the mobile station (UE1) 102 does not transmit data (NO at Step S1606), the base station (BS) 111 increments the count value t of the timer 1304 (Step S1608).

Subsequently, the base station (BS) 111 compares the count value t of the timer 1304 with the predetermined count-up value T4 (Step S1609). The count-up value T4 is set to a value corresponding to a case in which, for example, the mobile station (UE1) 102 ends the communication and continues to stop communications (corresponding to a time, for example, 10 minutes, in which the mobile station has exited the area X where interference has occurred).

If the count value t of the timer is smaller than the count-up value T4 (YES at Step S1609), the process returns to Step S1605 and the base station (BS) 111 continues to monitor a data transmission state of the mobile station (UE1) 102. In contrast, if the count value t of the timer is equal to or greater than the count-up value T4 (NO at Step S1609), the base station (BS) 111 determines that the communication is terminated because the mobile station (UE1) 102 is continuously in the non-communication state during the non-communication state period T4, transmits a signal of intermittent transmission stop (Step S1610), and ends the process.

Incidentally, a general-purpose base station (AP) can be used as the base station (AP) 101 of the fourth embodiment, and it is not needed to control intermittent transmission. Therefore, explanation of a flowchart or the like of a process related to the intermittent transmission will be omitted.

According to the above-described fourth embodiment, the base station (BS) 111 of the second wireless system B does not perform continuous transmission in the initial state, but provides the no-transmission interval T12. The mobile station (UE1) 102 of the first wireless system A located in the area X can send the intermittent transmission request to the base station (BS) 111 of the second wireless system B during a period in which there is no interference from the second wireless system B because of the no-transmission interval T12 provided after the busy state is continued. Furthermore, the mobile station (UE1) 102 of the first wireless system A can transmit data to the base station (AP) 101 because of the no-transmission interval T11 in the intermittent transmission performed by the second wireless system B.

Moreover, the mobile station (UE1) 102 of the first wireless system A can directly transmit the intermittent transmission request by radio to the base station (BS) 111 of the second wireless system B without through the first wireless system A. Therefore, it is possible to cause the second wireless system B to perform the intermittent transmission without using a resource of the first wireless system A.

In this case, the mobile station (UE1) 102 of the first wireless system A need not use a packet of a special frame as described in the third embodiment (see FIG. 14), and therefore can reduce a processing load.

Even in the fourth embodiment, when the mobile station (UE1) 102 of the first wireless system A is located in the area X, in which the different types of the wireless systems A and B overlap each other because of mixing of the wireless systems A and B, the mobile station (UE1) 102 can perform communication while avoiding interference from the second wireless system B. That is, it is possible to prevent the mobile station (UE1) 102 from continuing to remain in the busy state in which transmission is not possible, so that it is possible to improve the throughput of the first wireless system A.

Furthermore, the base station (BS) 111 of the second wireless system B monitors a communication state of the mobile station (UE1) 102 located in the area X by using the timer, and returns to the initial state (communication including the no-transmission interval T12) from the intermittent transmission after a period corresponding to the non-communication state of the mobile station (UE1) 102 has elapsed. As described above, according to the fourth embodiment, the base station (BS) 111 of the second wireless system B can always receive the intermittent transmission request from the mobile station (UE1) 102 of the first wireless system A, and can immediately perform the intermittent transmission. Furthermore, it is possible to perform the intermittent transmission only in a period in which the mobile station (UE1) 102 is located in the area X, so that the throughput is not reduced more than needed and reduction of the throughput can be reduced to the minimum.

Incidentally, the mobile communication system of the fourth embodiment includes the base station 101 and the base station 111, which use different wireless communication systems and the same frequency band, and includes the mobile station 102, which starts communication with the base station 101 after detecting presence or absence of transmission before the communication. The base station 111 includes the intermittent transmission control unit 303 that starts transmission with a no-transmission interval, based on the intermittent transmission request. The mobile station 102 includes the intermittent transmission request unit 405 that transmits an intermittent transmission request to the base station 111 when a state, in which transmission is not possible, is continued for a predetermined time due to the continuous transmission from the base station 111, and includes the transmitting unit 401 that transmits data in the no-transmission interval.

Furthermore, the mobile station 102 directly transmits the intermittent transmission request to the base station 111 by wireless communication.

Moreover, the base station 111 provides a no-transmission interval for each predetermined period, and the mobile station 102 transmits the intermittent transmission request to the base station 111 during the no-transmission interval if a state, in which transmission is not possible, is continued for a predetermined period.

Furthermore, the base station 111 stops the intermittent transmission if the mobile station 102 continues to stop communication with the base station 101 for a predetermined time.

In the above-described embodiments, it is assumed that the wireless system A, as one of the systems, serves as a base station (AP) using WLAN, and the wireless system B, as the other one of the systems, serves as a base station (BS) using cellular communication; however, it is not limited thereto. The technologies described in the embodiments may be applied to a combination of various wireless systems that use the same frequency when different types of wireless systems are mixed. Furthermore, the technologies described in the embodiments are not limited to various wireless systems that are applied to the TVWS as secondary systems using empty frequency bands, but may be applied to various wireless systems, which are located in a mixed manner and use the same frequency band, in the same manner.

According to a disclosed embodiment, even when a plurality of wireless systems using the same frequency are mixed in a single area, it is possible to reduce reduction of the throughput of an entire communication system.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication device in a communication system that includes a first wireless system employing a first communication method in which communication is started when a sensed power value is smaller than a first set value of a threshold, and includes a second wireless system employing a second communication method in which communication is performed by scheduling performed by a base station, the wireless communication device employing the first communication method, the wireless communication device comprising:
a processor that executes a process including:
determining presence or absence of interference from the second wireless system based on information received from a different wireless communication device employing the first communication method; and
changing the threshold to a second set value when determining that there is the interference.

2. The wireless communication device according to claim 1, wherein
the process further includes:
measuring, as the sensed power value, reception power of a signal received via an antenna; and
performing a reception process on the received signal, wherein
the determining includes determining that there is the interference when the signal subjected to the reception process includes information indicating that the second wireless system is located around the different wireless communication device and when a length of a period, in which the measured sensed power value is equal to or greater than the first set value, is equal to or greater than a predetermined value.

3. The wireless communication device according to claim 1, wherein
the process further includes:
measuring, as the sensed power value, reception power of a signal received via an antenna; and
performing a reception process on the received signal, wherein
the determining includes determining presence or absence of the interference, based on the information that is included in the signal subjected to the reception process and that indicates a position of the second wireless system located around the different wireless communication device, and based on a location of the wireless communication device.

4. The wireless communication device according to claim 1, wherein the changing includes calculating the second set value based on a ratio between reception power of the wireless communication device with respect to a signal transmitted from the different wireless communication device and needed communication quality.

5. A communication system comprising:
a first wireless system that employs a first communication method in which communication is started when a sensed power value is smaller than a first set value of a threshold;
a second wireless system that employs a second communication method in which communication is performed by scheduling performed by a base station;
a first wireless communication device that employs the first communication method; and
a second wireless communication device that employs the first communication method, wherein
the first wireless communication device includes:
a processor that executes a process including:
determining presence or absence of interference from the second communication system based on information received from the second wireless communication device; and
changing a value of the threshold to a second set value when determining that there is the interference.
